(19) United States
(12) Patent Application Publication
(10) Pub. No.: US 2014/0220531 A1
(43) Pub. Date: Aug. 7, 2014

(54) Creator's organ clock

(71) Applicant: Johnnie Watkins, Markham, IL (US)

(72) Inventor: Johnnie Watkins, Markham, IL (US)

(21) Appl. No.: 13/999,377

(22) Filed: May 4, 2012

(51) Int. Cl. G09B 23/28

(52) U.S. Cl. CPC G09B 23/28
USPC 434/272

(57) ABSTRACT

The invention relates to an improvement and advanced use of the 12 hour and 24 hour insert/facing of the clock to aid as a teaching tool to inform the individual of the time of day or night each organ comes on shift. The insert/facing of the clock will aid in determining which organ is most effective during a certain time of the 24 hour day. The advantage of knowing this will aid in determining which organ is weak. Pain at certain times depicts deficiency/weakness. this invention can be used by professionals in the health arena or by individuals. It also tells the time of the day using the 24 hour clock or the 12 hour clock.

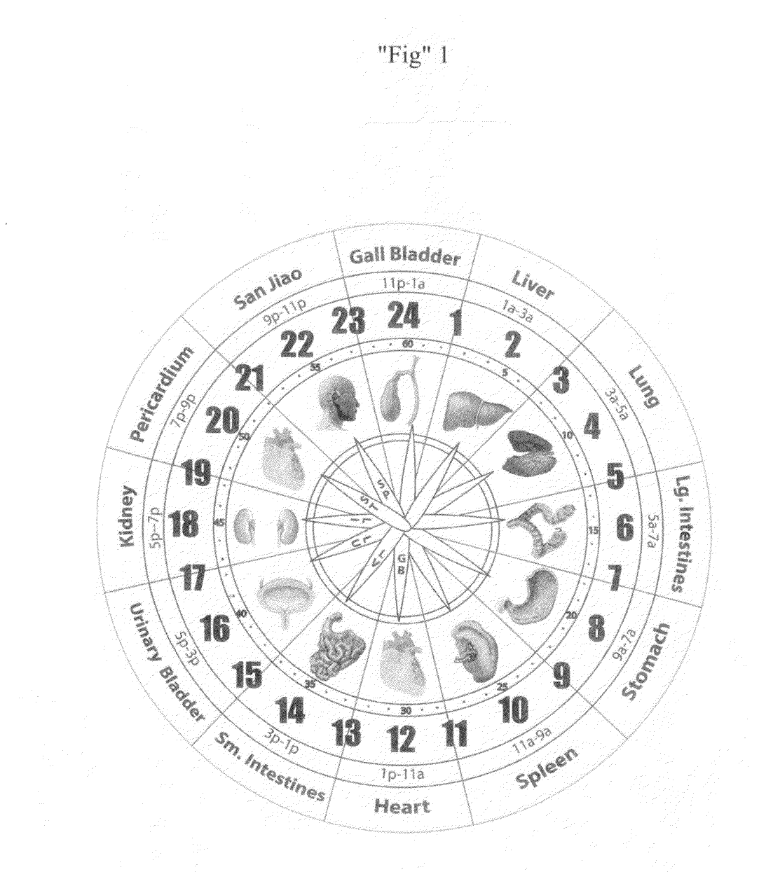

### BRIEF DESCRIPTION OF THE DRAWING OF FIG. 1

FIG. 1 is a teaching tool used to tell the time of the day or to help one to Understand how the body works. This tool is designed like a wall clock Which show the following:
1. The time of the day using, military time.
2. Which organ is working most efficient for two hour
3. What organ follows next.
4. What organ is directly or indirectly connected
5. What organ benefits or affected, twelve hours later.
6. What organ is depended on the other.
7. What time of the organ start working.

### BRIEF DESCRIPTION OF DRAWING “F” 2

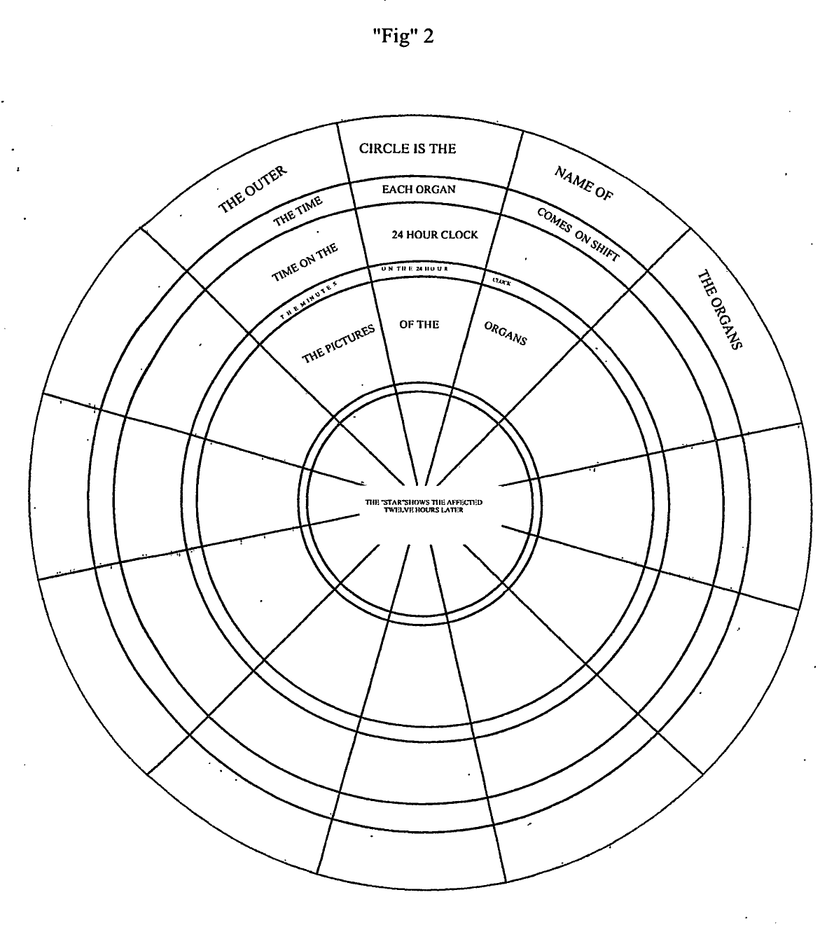

FIG. 2 gives the explanation of what each of the circle represents. This will help one to understand how to use the clock to determine its function or Purpose.

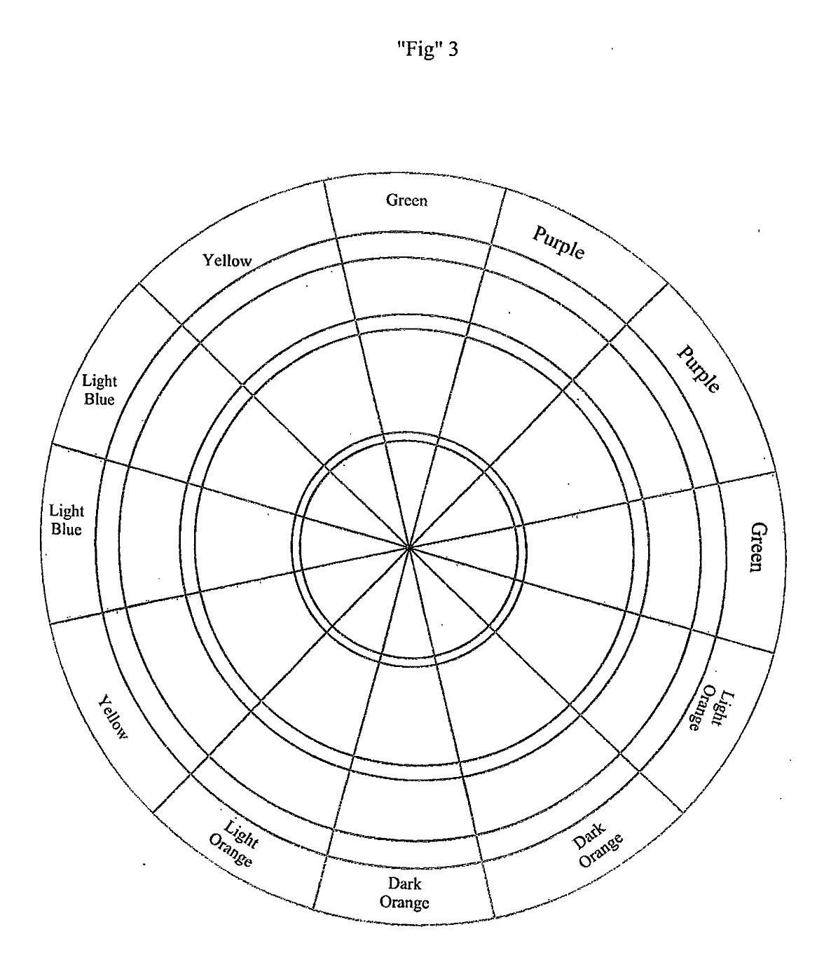

### BRIEF DESCRIPTION OF DRAWING OF FIG. 3

FIG. 3 is the color code to determine how the organ are paired. Every organ is paired with one other organ. These two organs have the same color.

| COLORS | PAIRED ORGAN |
|---|---|
| Light orange | Heart/kidney |
| Dark orange | Small intestine/Urinary Bladder |
| Yellow | Liver/Pericardium |
| Light Blue | Gall Bladder/San Jiao |
| Green | Lung/Spleen |
| Purple | Large intestine/Stomach |

### DETAILED DESCRIPTION OF DRAWING IN F5

The number on the clock has military time because of the 24 hours, showing each hour of the day.

It doesn't show the a.m. as 1:00 to 12:00 which is 1 am to 12 pm. It is known as 0100 for 1 am.

But it does show 13 to 24 which is known as 1 a.m. to 12 p.m.

| Like Military | Creator | | | Creator | |
|---|---|---|---|---|---|
| Time | body clock | | Military | Body clock | |
| 0100 | 1 | am | 13 | 1 | pm |
| 0200 | 2 | am | 14 | 2 | pm |
| 0300 | 3 | am | 15 | 3 | pm |
| 0400 | 4 | am | 16 | 4 | pm |
| 0500 | 5 | am | 17 | 5 | pm |
| 0600 | 6 | am | 18 | 6 | pm |
| 0700 | 7 | am | 19 | 7 | pm |
| 0800 | 8 | am | 20 | 8 | pm |
| 0900 | 9 | am | 21 | 9 | pm |
| 1000 | 10 | am | 22 | 10 | pm |
| 1100 | 11 | am | 23 | 11 | pm |
| 1200 | 12 | pm | 24 | 12 | pm |

Precise time on the 12 hour clock cannot show how the organ works hourly. It can only be shown on a 24-hour clock.

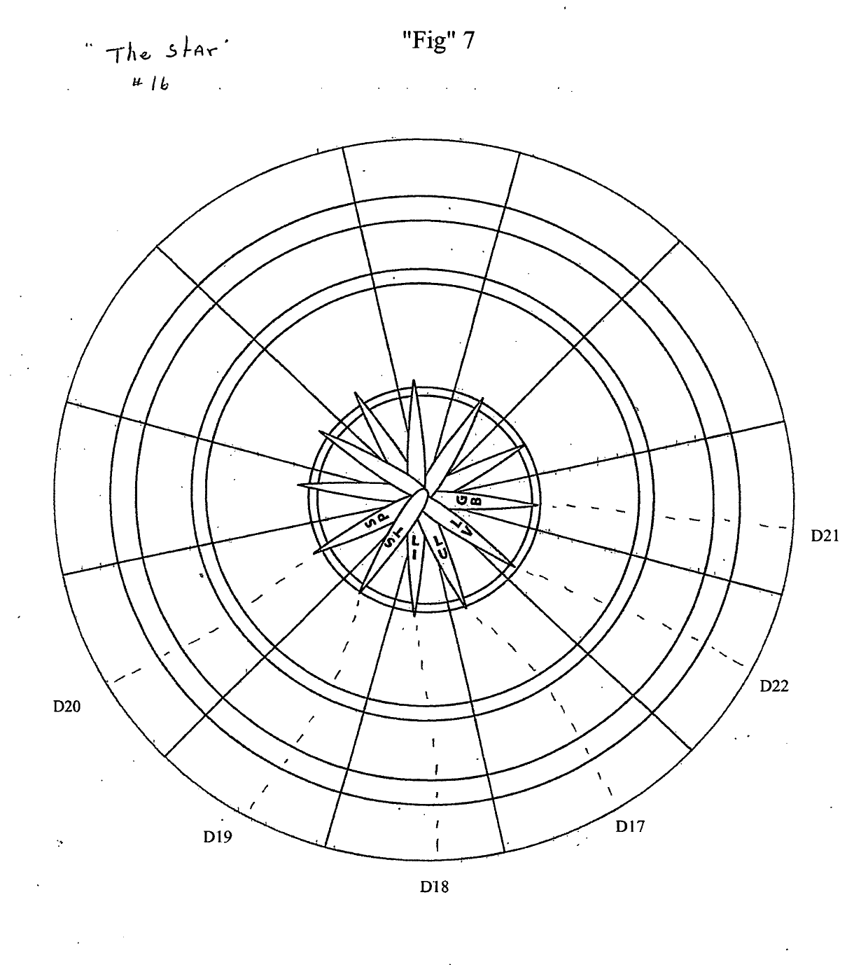

### BRIEF DESCRIPTION OF DRAWING FIG. 7

The initials in the star points to the organ that will possibly be affected, twelve hours later.
GB/HT Gall bladder/Heart
LV/SM Liver/Small intestine
LU/UB Lung/Urinary Bladder
LI/KD Large Intestine/Kidney
ST/PC Stomach/Pericardium
SP/SJ Spleen/Pericardium

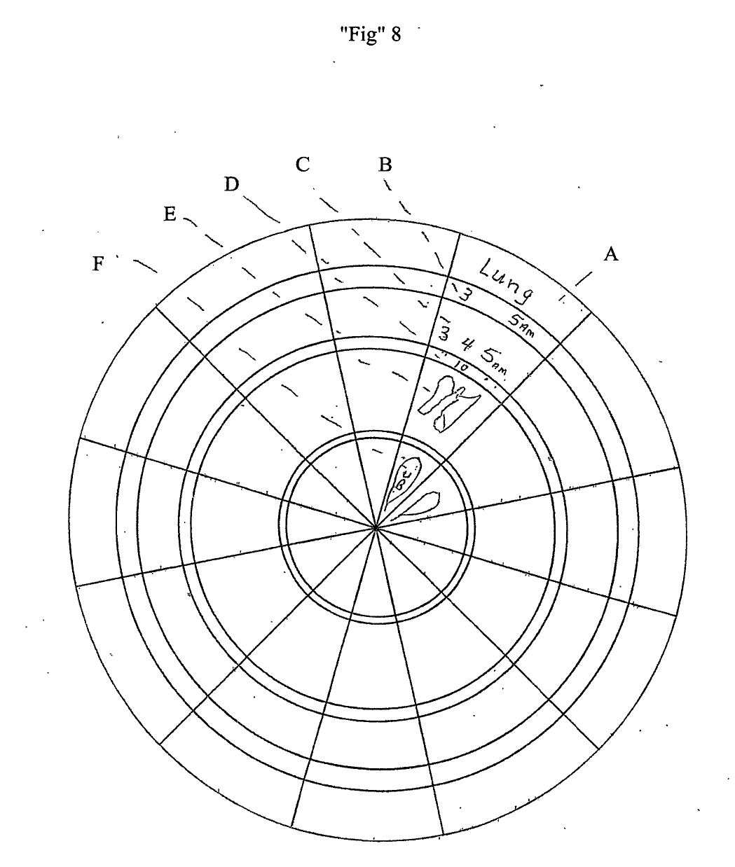

### BRIEF DESCRIPTION OF DRAWING FIG. 8 (A B C D E F)

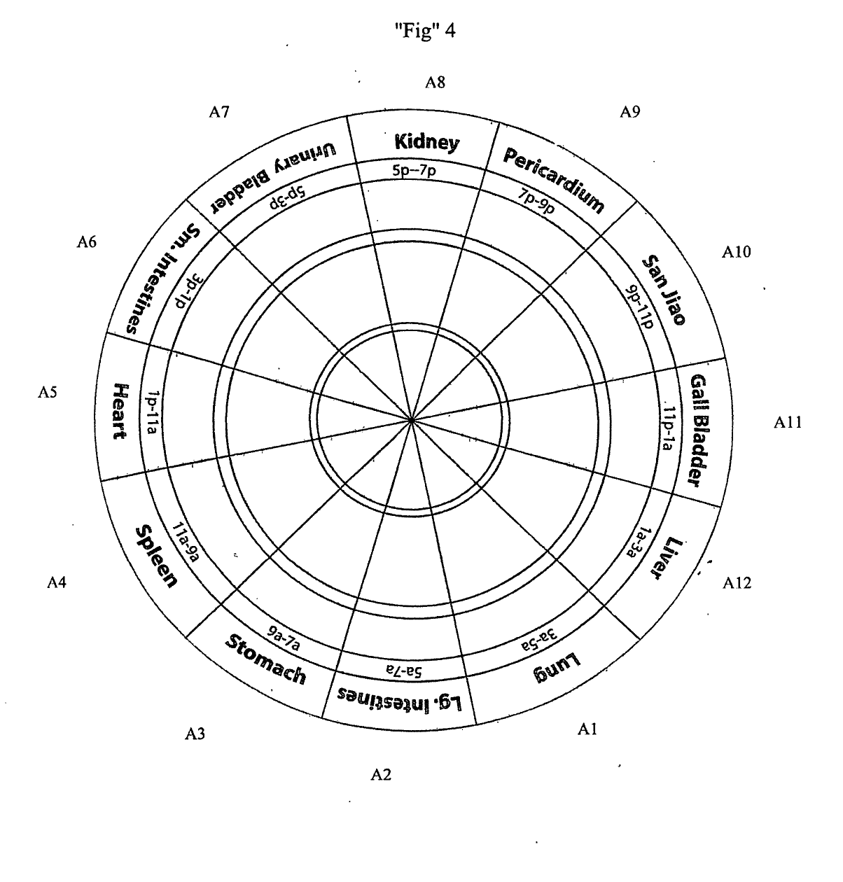

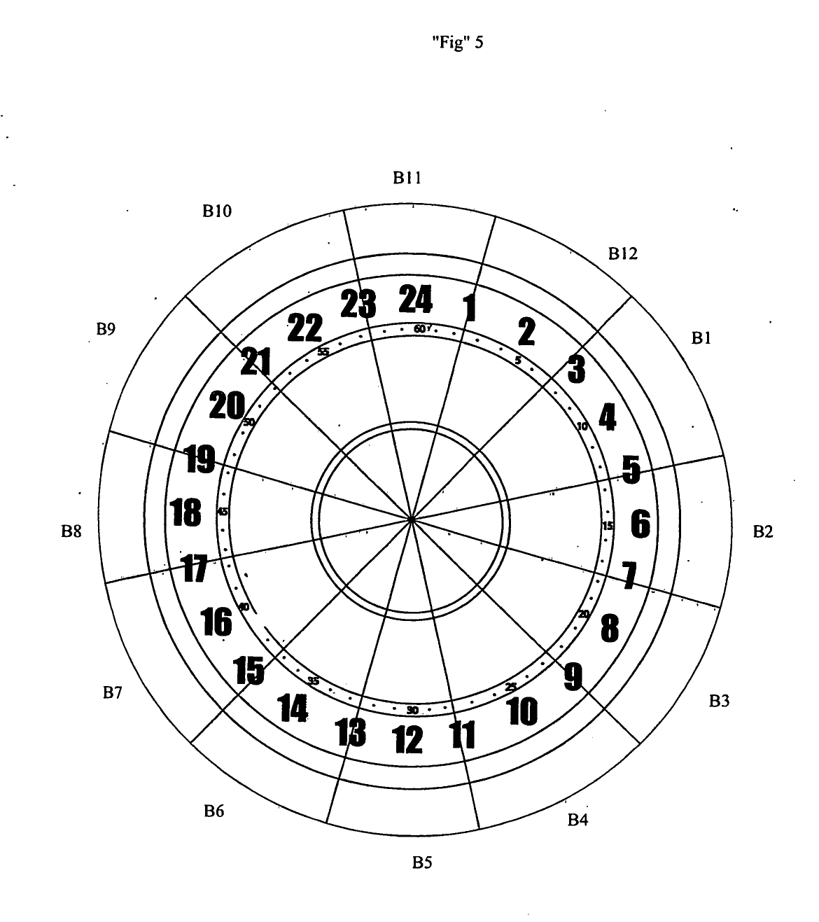

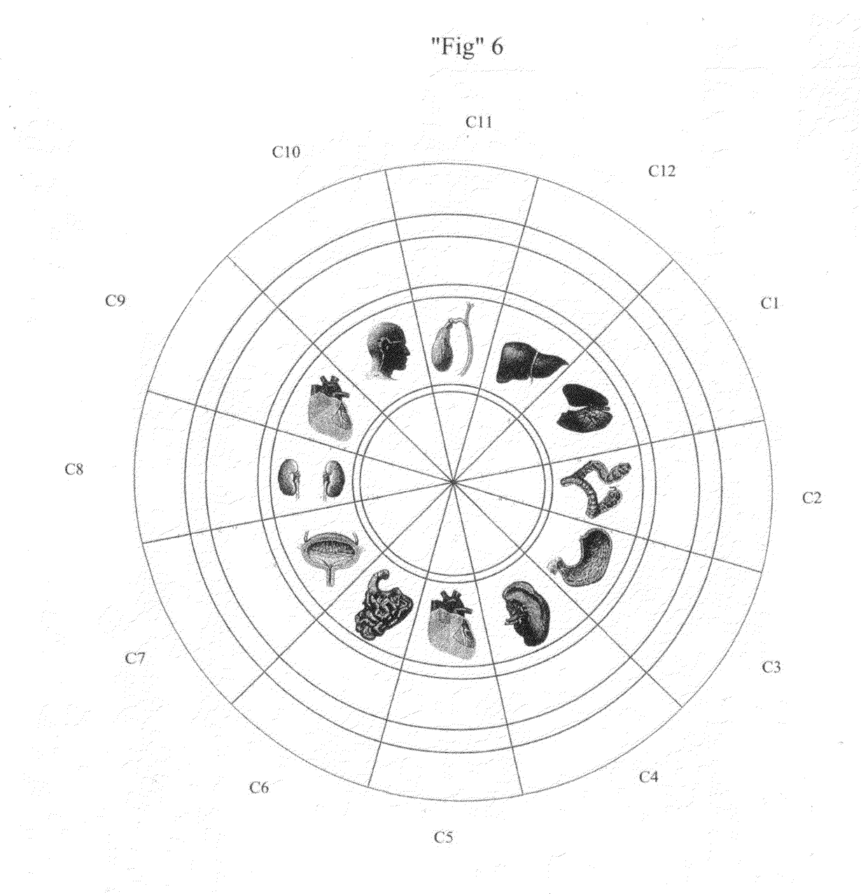

FIG. 8 is a brief description of each of the squares, using the picture of the lung in FIG. 6.
A shows the name of the organ/channel This is represented in FIG. 4.
B shows the time the organs/channels that's working most effective for two hours on a twenty four clock. This is represented in FIG. 4
C shows the hours on the twenty four clocks. This is represented in FIG. 5
D shows the minutes on a twenty four clock. This is In FIG. 5.
E shows the picture of which organ is working, most effective, during this time of the day. This is represented in FIG. 6.
F shows which organ will be affected twelve hours later. This is represented in the star in FIG. 7. D 17 to 22 show the organ which can affect the organ in the “star”.

### OBJECTS OF THE INVENTION

FIG. 4

A1 to A12
1. Lungs 3 AM-5 AM
2. Large Intestine 5 AM-7 AM
3. Stomach 7 AM-9 AM
4. Spleen 9 AM-11 AM
5. Heart 11 AM-1 PM
6. Small Intestine 1 PM-3 PM
7. Urinary Bladder 3 PM-5 PM
8. Kidney 5 PM-7 PM
9. Pericardium 7 PM-9 PM
10. San Jiao 9 PM-11 PM
11. Gall Bladder 11 PM-1 AM
12. Liver 1 AM-3 AM

FIG. 5

B1-B12
13. Large Numbers (1-24) is the 24 hours of the day.
14. Small Numbers (5-60) is the minutes in the hour.

FIG. 6

C1-C12
15. The picture of each organ/channel

FIG. 7

D17-D22
16. Star figure (12 points with 6 arrows with initials) show twelve apart
17. U B Shows points to the lungs picture
18. KD arrow points to the Large Intestine picture.
19. PC arrow points to the stomach picture
20. SJ arrow points to the Spleen picture
21. GB arrow points to the Heart picture
22. LV arrow points to the Small Intestine
23. Squares with the same color shows how the organs are paired as shown in figure
as shown in #3

1. I claim that the improved design of the facing/insert of the” creator's organ clock is a teaching tool that can be used by health professionals, alternative care practitioners, students and individuals to aid in understanding how the organs come on shift. The insert/facing comprises of six circles that are divided into 12 squares with multiple colors with 2 of the squares matching to demonstrate how the organs are paired. The outer circle is the largest circle that has 5 circles within the outer circle. Each of the 5 circles has a smaller circle within. The smallest circle in the center has a 12-pointed arrow star in it's center that has the same color as the square. (color shown in FIG. 3) Six of the arrows are labeled with initials: UB, KD, PC, SJ, GB and LV (shown in FIG. 7 only) which are the organs affected 12 hours later. Each of the 12 arrows on the star in the center points to a picture/square. Each square in the circle includes the name of one of the 12 organs (lungs, large intestines, stomach, spleen, heart, small intestines, urinary bladder, kidney, pericardium, San Jiao, gall bladder and liver). Each square includes the 2 hours it comes on shift, in the use of a 24 hours clock. (numbers 1-24 represent the 24 hours of the day). Number 5 through 60 represents the minutes of the hour and shows the picture of one of the 12 organs). An improved insert/facing teaching tool will be mounted in the frame of the 12 hour or 24 hour clock/watch. It will also be displayed on other items but not conclusive of: The Bible covering, linen, curtains, calendars, traveling cases, jewelry, drinking glasses, cups, plates, key rings, tote bags, rugs, towels, treatment table coverings, refrigerator magnets, placed in picture frames, digital clocks and on CDs and DVDs the size of the insert/facing will vary from 1 inch to 50 inches. The shape of the insert/facing will vary in design: circle, triangle, square, diamond or rectangular.
